(19) United States
(12) Patent Application Publication
(10) Pub. No.: US 2016/0310772 A1
(43) Pub. Date: Oct. 27, 2016

(54) Collection and Recycling System for Contents of Sprinkler System

(71) Applicant: Kenneth Tabor, Flower Mound, TX (US)

(72) Inventor: Kenneth Tabor, Flower Mound, TX (US)

(21) Appl. No.: 14/692,501

(22) Filed: Apr. 21, 2015

(51) Int. Cl. A62C 35/68; A62C 35/60

(52) U.S. Cl. CPC A62C 35/68; A62C 35/60

(57) ABSTRACT

A system and method for the collection, decontamination, and re-use of fluids such as water drained from a fire sprinkler system. Typically, water is drained from a sprinkler system to complete repairs or maintenance. The present system prevents the wasting of clean, treated water from the city water supply to refill sprinkler systems, clean water is conserved and contaminated water is filtered and reused in the sprinkler system. This system prevents the release of contaminated water into the public water supply and saves gallons of fresh, new water from entering the sprinkler system where it would eventually be contaminated released back into the environment. Water is drained from the sprinkler system through a hose towards a storage bag or tank. A pump assists with removal of water from storage bag while a filter removes contaminants as the water flows back to the fire sprinkler system.

### CROSS-REFERENCE TO RELATED APPLICATIONS

Priority is claimed to the provisional filed on May 22, 2014 (Application 62/001,947) entitled Water Collection and Re-Use Device.

### TECHNICAL FIELD

The present invention relates to a building fire safety systems and specifically to devices for collection and recycling contents from sprinkler systems.

### DESCRIPTION OF PRIOR ART

Many commercial building use fire sprinklers systems. The sprinkler systems typically use steel pipes to store the water. Typically, each sprinkler in is plugged by a heat-sensitive detector, which releases water when a specific temperature is reached. The sprinkler system may activate only the sprinklers near the heat source or all of the sprinkler may be activated simultaneously. The water inside the fire sprinkler pipes may sit stagnant for years until repair or maintenance is required for the system. Unfortunately, this stored water may stagnate and become adulterated or polluted by oils, sediment, metals, chemicals, as well as other contaminants.

When the fire sprinkler system needs to be repaired, the contaminated water is typically drained from the system into the street where it flows into the water supply via creeks, lakes, streams, etc. In addition, once the repair is made, the system will need to be refilled with new water. The release of the water and the refill of the sprinkler system may result in the usage of possibly hundreds or thousands of gallons of water. Over the years, this wastefulness can create significant financial strain from the cost of gallons of water, an environmental hazard each time the polluted water is released into the environment, as well as a strain on the municipality if this release and refill occurs during a drought situation.

While draining a sprinkler system, workers need to ensure that water will flow into drain inlets or sewer drains (if permitted by city ordinance) once released from the fire sprinkler system. They will also need to verify that the drain inlets are actually open and free of debris that may block the flow of water into the drain. The workers will also need to ensure that the released water will not cause flooding or damage to nearby property, structures, equipment, vehicles, or even pedestrians or nearby traffic. An additional concern is the safety hazards created by slick walking or parking surfaces upon the release of the contaminated water. Workers also need to ensure that curbs or ditches are able to handle the discharge flow of contaminated water and prevent the buildup of undesirable and difficult to remove silt or sediment. The contaminated water also may potentially harm plant life that it contacts upon its release or cause erosion of nearby soils. Workers also have the option of creating dams or other structures to direct the flow and limit damage cause by the release of the contaminated water, however these options involve additional skill, expense, and time.

The present collection and recycling system addresses many of these concerns by removing and storing the released fire sprinkler water in a nearby location outside of the sprinkler system while the fire sprinkler system undergoes repairs or maintenance. After the completion of repairs or maintenance, the stored water may be redirected to the fire sprinkler system to refill the pipes of the fire sprinkler system, thereby saving water, preventing water damage to nearby structures and preventing the release of possibly contaminated water into the public water system.

### OBJECTS OF THE INVENTION

A primary object of the present collection and recycling system is to collect, store, and recycle water from fire sprinkler systems.

It is another object of the present collection and recycling system to decontaminate and re-use fire sprinkler system water.

It is another object of the present collection and recycling system to conserve precious fresh water resources by reusing fire sprinkler system water.

It is another object of the present collection and recycling system to provide convenient and portable storage for fire sprinkler water during collection, decontamination, and reuse.

It is another object of the present collection and recycling system to prevent damage to surrounding water systems, property, plant life and persons from the release of unclean fire sprinkler system water.

It is another object of the present collection and recycling system to conserve water resources by storing, cleaning, and reusing fire sprinkler water.

It is another object of the present collection and recycling system to conserve water from mechanical systems such as water chiller and HVAC water systems.

### SUMMARY OF THE INVENTION

The present collection and recycling system (CRS) is a system for the collection, decontamination, and re-use or recycling of the contents drained from a fire sprinkler system. The substance within the sprinkler system, water in this embodiment, may be drained from a fire sprinkler system to complete repairs or maintenance within the fire sprinkler lines. Use of the present collection and recycling system prevents the wasting of clean, treated water from the city water supply to refill fire sprinkler systems and also prevents the release of potentially contaminated water previously stored within fire systems into the storm drains, sewer, lakes, and public water supply. The present collection and recycling system ensures that contaminants from fire sprinkler water are not released into the storm sewer system and saves thousands of gallons of freshly treated public water from entering the fire sprinkler system where that water would eventually be contaminated with oils and sediments prior to eventually being released back into the environment the next time the fire sprinkler system is drained.

Commercial buildings often utilize fire sprinkler systems that store water until said water is needed for a fire emergency or a repair needs to be made on the fire sprinkler system. The water stored in the systems may be exposed to sediment, dirt, rust as well as a host of other contaminants. The present CRS may be used in conjunction with the fire sprinkler drain to remove the existing water from the fire sprinkler system. Once it is determined that the fire sprinkler system must be drained, the contaminated water will be removed from the fire sprinkler system through the fire sprinkler drain or the fire department connection supply. The fire sprinkler drain has an end point at the exterior of a building. A drain hose is attached to the fire sprinkler drain to direct the water toward the reclaim bag, a storage container located outside the building. Fire sprinkler water leaves the drain hose and enters the reclaim bag. The reclaim bag includes an air vent to normalize pressure within the reclaim bag and ensure that pressure doesn't build to high levels.

Once the repairs or maintenance are completed on the fire sprinkler system, the water collection and reuse system may be utilized to refill the existing sprinkler system with the filtered and recycled water which was temporarily held in the reclaim bag. After repairs or maintenance are completed, the fire sprinkler water may be redirected back to the fire sprinkler system. Opening of the air vent and the valve, both on the reclaim bag, facilitates faster draining of the fire sprinkler water from the reclaim bag through the drain hose. In addition, a pump is located outside the reclaim bag to further assist in the removal of water from the reclaim bag. The pump also forces the fire sprinkler water along the drain hose and through the filter. The filter removes contaminants and impurities from the previously used and stored fire sprinkler water. After passing through the filter, the pump continues to direct the decontaminated fire sprinkler water on its passage through the drain hose, en route to the fire sprinkler system in the building. The filtered fire sprinkler water may return to the fire sprinkler system through either the fire sprinkler drain from which it initially exited the building or through the fire department connection.

Typically, the fire department would access the fire department connection (FDC) for a fire hose at the exterior of the building. The fire department connection supply to the building is commonly used by the fire department to pump water into the fire sprinkler system if the municipal water system fails or is otherwise unavailable. Typically, a building will have a single fire department connection whose pipes are interconnected throughout the building thus allowing water to fill the entire fire sprinkler system through a single entry point. The user of the present CRS system may decide whether to use the fire sprinkler drain or FDC as a re-entry point for the filtered fire sprinkler water. The present system conserves water during fire sprinkler system repairs and maintenance as well as filters stagnant and potentially contaminated water for recycling into the existing fire sprinkler system.

The substance, water in this instance, stored in the sprinkler system may be discharged from the fire sprinkler system via a fire sprinkler drain, which are located throughout the building and are interconnected to each other. The force of gravity will direct the water through the fire sprinkler drain as the water exits the fire sprinkler system. A hose connected to the fire sprinkler drain further directs the flow of water outside of the building in which the fire sprinkler system is housed. Sprinkler system water leaving the building at the connection point through a standard size fire hose flows toward a reclaim bag. The reclaim bag serves as a holding area for the water previously stored in the sprinkler system. The reclaim bag includes a valve to control initial flow into the reclaim bag and an air vent to facilitate additional flow into the reclaim bag.

In the present system, a valve is positioned between the standard hose and the reclaim bag to control the flow of sprinkler system water into the reclaim bag. If the valve is in an open position, the sprinkler water will flow until the sprinkler system is emptied of water or until the reclaim bag is full. If the valve is in an off position, sprinkler water will not flow in/out of the reclaim bag or sprinkler system. In addition, the reclaim bag also includes an air vent to further facilitate the flow of sprinkler water into the reclaim bag by allowing additional air in to the reclaim bag. If the reclaim bag is full, water will not flow from the fire sprinkler system since it will have nowhere to go. If the reclaim bag is full, the air vent may be opened to allow for continued release of the fire sprinkler water, however, if this is done, potentially contaminated water will be released from the reclaim bag.

Once the water starts to depart the sprinkler line, it will immediately flow into a hose connected to a reclaim bag placed outside the building. The reclaim bag or storage bag may be constructed of a significantly sturdy material and may have the capacity to store hundreds or thousands of gallons of water, depending on the dimensions of the reclaim bag. However it is to be understood that storage bags of varying sizes may be used in conjunction with the present system depending on the capacity of the fire sprinkler system as well as the amount of water to be stored. The storage bag also includes an air vent to help normalize the pressure within the storage or reclaim bag. The reclaim bag may be placed in a vehicle parking space or other non-obtrusive location near the building that is within the length of the hose. It is also to be understood that a longer hose may be utilized if the reclaim bag is to be positioned further away from the building. The fire sprinkler water may be stored indefinitely in the reclaim bag. More commonly, the fire sprinkler water will be temporarily stored while repair or maintenance work is performed on the fire sprinkler system of the building.

Once the repairs or maintenance are completed for the fire sprinkler system, the water may be removed from the reclaim bag and the fire sprinkler lines refilled with the same water that was previously discharged. The sprinkler are closed while water is pumped back into the pipes since the fire sprinkler system is a closed system. In order to recycle or redirect the flow of water back toward the building. The pump pulls the water from the storage bag and pushes said water through a filter device toward the existing fire sprinkler system in the building. The filter device removes sediment, soils and other contaminants. Different filters can be utilized to address a variety of possible sediments or contaminants present in the fire sprinkler water. The filtered water is pumped back through the hose connection means towards the fire sprinkler system. The recycled water may re-enter the fire sprinkler system through either the fire department connection or the fire sprinkler drain depending on which point the user connects the hose. The same water that was removed from the fire sprinkler system is now refilling the fire sprinkler system as clean, filtered water, in contrast to its prior contaminated state.

The present system prevents the potential waste of thousands of gallons of contaminated water that usually occurs when a fire sprinkler system is drained into the street or parking lot, with unclean water eventually making its way to the municipal water system. With the present collection and recycling system, the water is not wasted and does not contribute to pollution but instead recycled and reused to refill the existing fire sprinkler system. The present system prevents the release of contaminated water into the environment by first, filtering the contaminants from the recycled water; and secondly, reusing the original fire sprinkler water to refill the fire sprinkler system. Surrounding property and plant life are not subjected to the release of potentially hazardous fire sprinkler water.

### BRIEF DESCRIPTION OF THE DRAWINGS

FIG. 1 shows the overall process to drain water from sprinkler system;

Ref. 1 fire sprinkler drain

Ref. 2 FDC supply to sprinklers

Ref. 3 standard fire hose

Ref. 4 fire system drain connection

Ref. 5 existing fire sprinkler system

Ref. 6 reducing tee

Ref. 7 FDC check valve

Ref. 8 FDC connection

Ref. 11 valve

Ref. 12 air vent

Ref. 13 sprinkler system water

Ref. 14 reclaim bag

FIG. 2 shows a close up view of the draining process;

Ref. 1 fire sprinkler drain

Ref. 2 FDC supply to sprinklers

Ref. 3 standard fire hose

Ref. 4 fire system drain connection

Ref. 5 existing fire sprinkler system

Ref. 6 reducing tee

Ref. 7 FDC check valve

Ref. 8 FDC connection

FIG. 3 shows a close up view of the drained water in reclaim bag;

Ref. 3 standard fire hose

Ref. 11 valve

Ref. 12 air vent

Ref. 13 sprinkler system water

Ref. 14 reclaim bag

FIG. 4 shows the overall process of sprinkler water refilling the sprinkler system;

Ref. 1 fire sprinkler drain

Ref. 2 FDC supply to sprinklers

Ref. 3 standard fire hose

Ref. 4 fire system drain connection

Ref. 5 existing fire sprinkler system

Ref. 6 reducing tee

Ref. 7 FDC check valve

Ref. 8 FDC connection

Ref. 9 filter

Ref. 10 pump

Ref. 11 valve

Ref. 12 air vent

Ref. 13 sprinkler system water

Ref. 14 reclaim bag

FIG. 5 shows a close up view of the filter and pump process;

Ref. 3 standard fire hose

Ref. 9 filter

Ref. 10 pump

FIG. 6 shows the filling of a fire system with existing water with flow from hose to building

Ref. 1 fire sprinkler drain

Ref. 2 FDC supply to sprinklers

Ref. 3 standard fire hose

Ref. 4 fire system drain connection

Ref. 5 existing fire sprinkler system

Ref. 6 reducing tee

Ref. 7 FDC check valve

Ref. 8 FDC connection

### DETAILED DESCRIPTION OF DRAWINGS

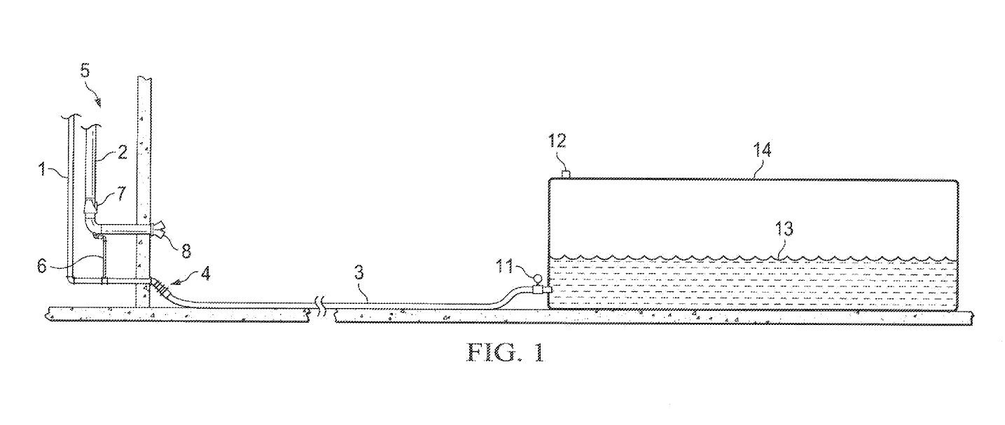

While the above description is of the preferred embodiment of the present invention, it should be appreciated that the invention may be modified, altered, or varied without deviating from the scope and fair meaning of the following claims. Referring generally to FIGS. 1-6, the present disclosure is a system and method for the collection, decontamination, and re-use of water drained from a fire sprinkler system.

FIG. 1 shows the overall process to drain water from an existing sprinkler system 5 using the present CRS. Water in the sprinkler system 5 may exit the through a fire sprinkler drain 1 connected to the sprinkler system on a first end and the exterior of the building at a second end of the sprinkler system. A standard fire hose 3 may be connected to the exterior of the building at the fire sprinkler drain or FDC supply to sprinklers 2 to facilitate removal and flow of water from the building. Water from the sprinkler system will flow away from the building and existing fire sprinkler system 5 towards the reclaim bag 4. The drained fire sprinkler water will have to pass through a valve 11 prior to entering the reclaim bag. However, the valve 11 may be adjusted to control the rate of flow of water into the reclaim bag. In addition, the reclaim bag includes an air vent 12 to further facilitate the flow of fire sprinkler system water 13 into the reclaim bag.

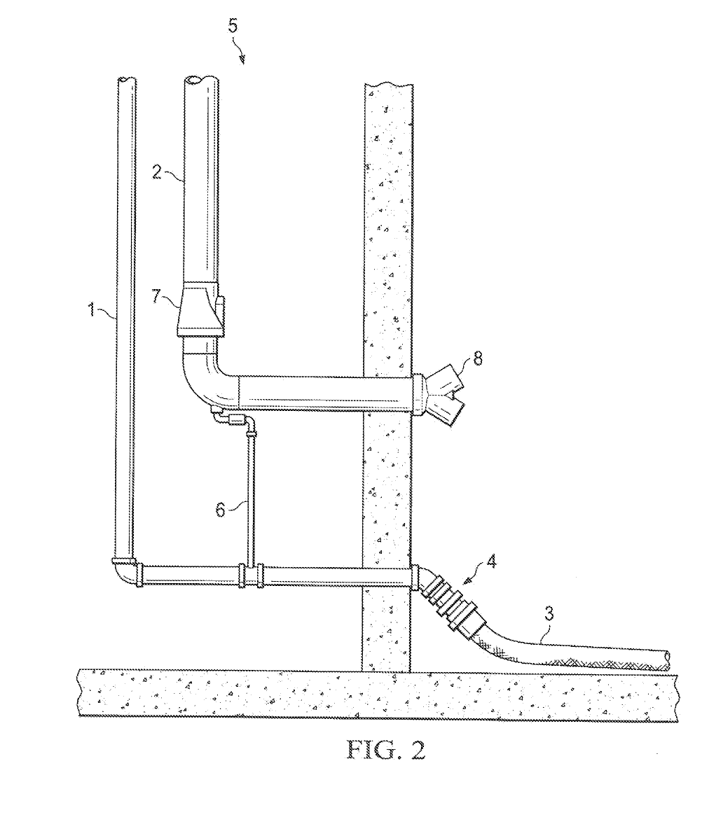

FIG. 2 shows a close up view of the sprinkler maintenance system as water exits the existing sprinkler system and building. Water in the sprinkler system 5 may exit through a fire sprinkler drain 1, connected to the sprinkler system on a first end and the exterior of the building at a second end. A standard fire hose 3 may be connected to the exterior of the building, at the fire sprinkler system drain connection 4, to facilitate removal and flow of water from the building. This view also shows the fire department connection at the exterior of the building. The FDC supply to the sprinklers is a pipe connection the sprinkler system and the FDC connection 8 at the exterior of the building. The FDC supply is adjacent to an FDC check valve 7, which controls flow of water into the fire sprinkler system. A reducing tee 6, positioned between the FDC check valve 7 and FDC connection 8, directs any overflow water to the fire sprinkler drain and prevents flooding of the system.

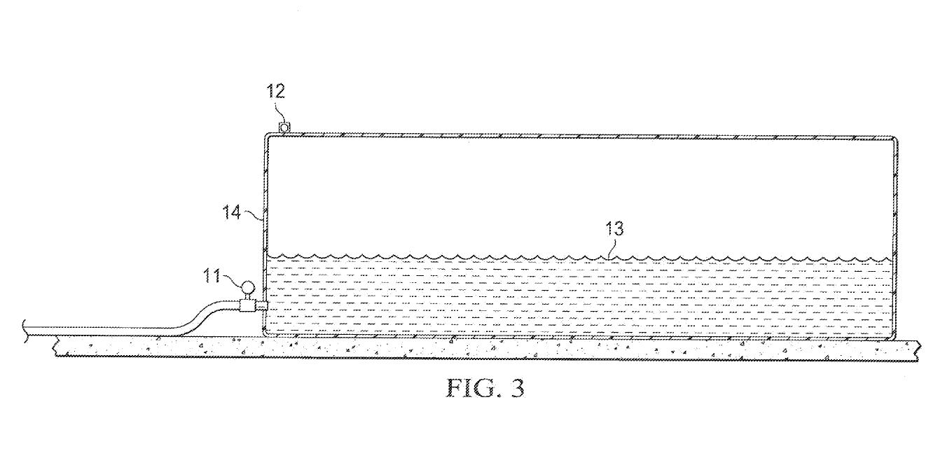

FIG. 3 shows a close up view of the drained water flowing to the reclaim bag. A standard fire hose 3 may be connected to the exterior of the building at the fire sprinkler drain 1 to sprinklers to facilitate removal and flow of water from the building. Water from the sprinkler system will flow away from the building and existing fire sprinkler system 5 towards the reclaim bag 4. The drained fire sprinkler water will have to pass through a valve 11 prior to entering the reclaim bag. If the valve 11 is closed, the flow of water from the existing fire sprinkler system will cease. If the valve 11 is open, fire sprinkler water will flow freely until the reclaim bag is full or the fire sprinkler system is emptied. However, the valve 11 may be adjusted to control the rate of flow of water into the reclaim bag. In addition, the reclaim bag includes an air vent 12 to further facilitate the flow of fire sprinkler system water 13 into the reclaim bag. The valve 11 at the entry point of the reclaim bag may be closed to prevent the release of water from the reclaim bag once the fire sprinkler system is emptied.

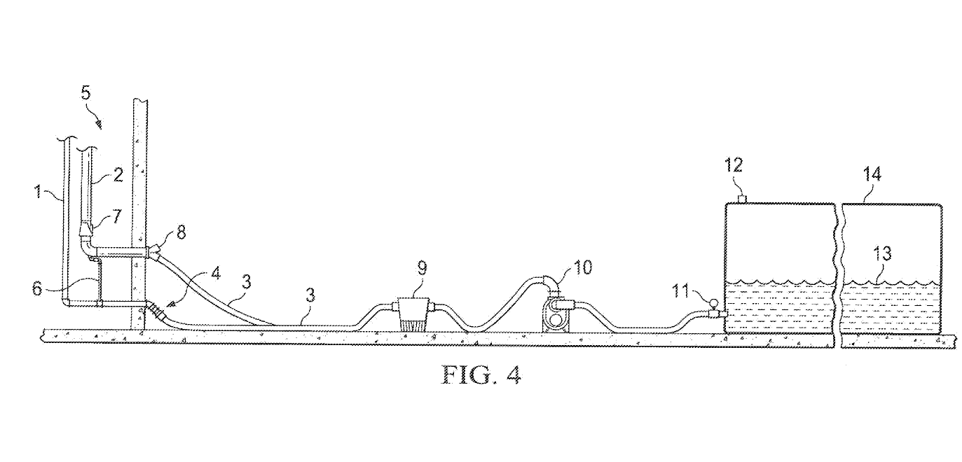

FIG. 4 shows an overview of sprinkler water flowing from reclaim bag to fire sprinkler system. Since the fire sprinkler system is closed, the individual sprinkler heads are closed while water is pumped back into the pipes of the fire sprinkler system. Once repairs or maintenance have been done on the fire sprinkler system, the used water may be returned to the fire sprinkler system. In order to facilitate flow of water from the reclaim bag 4 and into the standard fire hose 3, multiple features of the sprinkler maintenance system collaborate to remove the water: the air vent 12 may be opened, the valve 11 be opened, and the pump 10 activated. Opening of the air vent 12 on the reclaim bag allows air to enter the reclaim bag and assist with the redirection of the water out of the reclaim bag. Opening of the valve 11 the reclaim bag creates also creates an opening for the removal of the water from the reclaim bag. To further facilitate removal of the water from the bag, the pump pulls water from the reclaim bag at a first end and pushes water back towards the optional filter 9 between the pump and fire sprinkler system. The filter 9 may remove impurities and contaminants from the water at the water passes through the filter on its way back to the building and fire sprinkler system 5. Once the recycled water passes the pump 10 and filter 9, the water is directed towards the existing fire sprinkler system in the building. The recycled water may enter the building through either the FDC or the fire sprinkler drain connection 4. If the hose is connected to the FDC, the water will then flow through the FDC valve and FDC supply to sprinkler 2 before re-entering the sprinkler system. Any overflow water will flow into the reducing tee 6 and into the fire sprinkler drain 1. If the hose is connected to the fire sprinkler system drain connection 4, the water will flow through the fire sprinkler drain and into the existing fire sprinkler system. Since the water is now flowing against the force of gravity, the pump must be of sufficient strength to overcome the force of gravity.

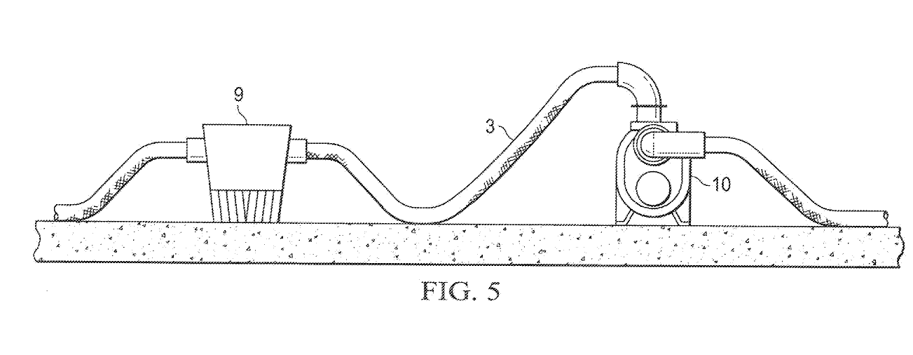

FIG. 5 shows a close up view of the filter and pump process. To further facilitate removal of the water from the reclaim bag, the pump 10 pulls water from the reclaim bag through the standard fire hose 3 at a first end of the pump 10 and pushes water back towards the optional filter 9 on the second end of the pump 10. The filter 9 may remove impurities and contaminants from the water at the water passes through the filter on its way back to the building and fire sprinkler system 5.

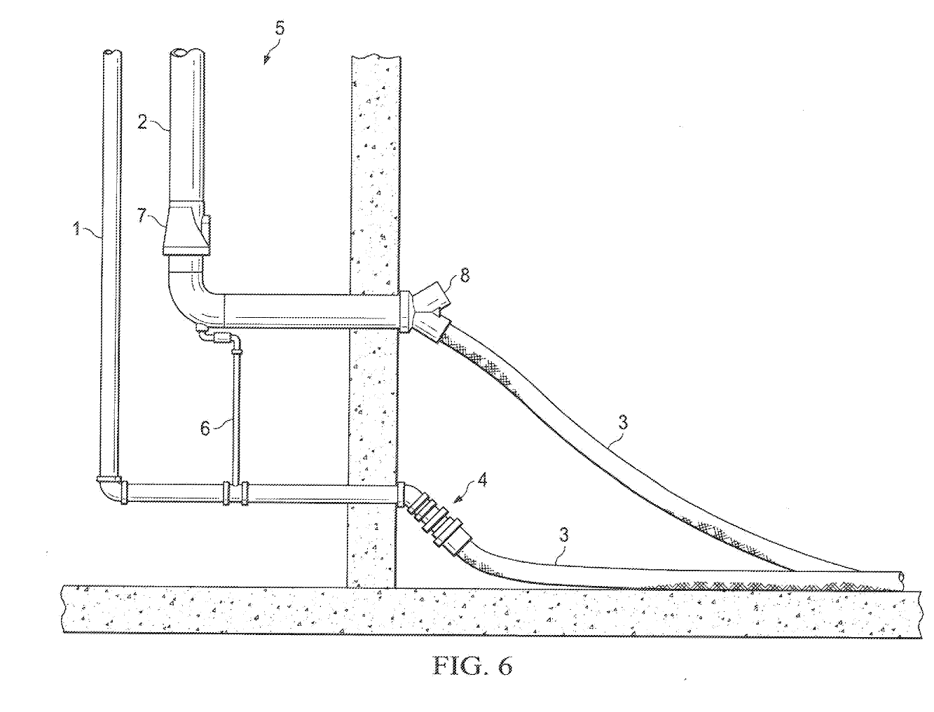

FIG. 6 shows the filling of a fire system with existing water with flow from reclaim bag to building. The standard fire hose 3 may be connected to the building at either the FDC or the fire sprinkler system drain connection 4. If the hose is connected to the FDC, the water will then flow through the FDC valve and FDC supply to sprinkler 2 before re-entering the sprinkler system. Any overflow water will flow into the reducing tee 6 and into the fire sprinkler drain 1. If the hose is connected to the fire sprinkler system drain connection 4, the water will flow through the fire sprinkler drain and into the existing fire sprinkler system.

What is claimed is:

1) A collection and recycling system for the removal and reuse of material, comprised of:
a primary material storage device;
a drainage system connected to said primary material storage system;
a transport device connected to said drainage system; and
a secondary material storage device connected to said transport device.

2) The collection and recycling system of claim 1, wherein said primary storage device is comprised of: at least one pipe wherein said material is retained within said pipe.

3) The collection and recycling system of claim 1, wherein said drainage system is comprised of: at least one drain to facilitate the flow of said material and at least one valve to control the flow of said material through said valve.

4) The collection and recycling system of claim 1, wherein said a first end of said transport device is connected to said drainage system.

5) The collection and recycling system of claim 1, wherein said secondary material storage device is comprised of:
a vessel for storing materials,
an entrance point; and
an air vent.

6) The collection and recycling system of claim 5, wherein a second end of said transport device is connected to said entrance point of said secondary material storage device.

7) The collection and recycling system of claim 6, wherein a pump is positioned at a point along said transport device between said primary material storage device and said secondary material storage device, wherein said pump facilitates movement of said material within said transport device, wherein said material moves between said secondary material storage device and said primary material storage device.

8) The collection and recycling system of claim 7, wherein a filter is positioned at a point along said transport device between said primary material storage device and said secondary material storage device, wherein said pump facilitates movement of said material through said filter.

9) The collection and recycling system of claim 3, wherein said drainage system is selected from the group consisting of: fire department connection supply and fire sprinkler system drain.

10) The collection and recycling system of claim 3, wherein said drain is selected from the group consisting of: fire department connection supply and fire sprinkler system drain.

11) The collection and recycling system of claim 5, wherein said secondary material storage device is selected from the group consisting of: a bag, a building, a commercial structure, a residential structure, and a holding structure.

12) A method of draining an emergency fire sprinkler system, the method comprising:
Connecting a first end of a transport device to a fire sprinkler system exit point;
Connecting a second end of a transport device to a valve on a storage vessel;
Opening a vent on said storage vessel;
Releasing the contents of said fire sprinkler system through said fire sprinkler system exit point;
Closing said fire sprinkler system exit point after the removal of said contents of said fire sprinkler system;
Closing said valve on said storage vessel after the removal of said contents of said fire sprinkler system;

13) A method of recycling, filtering and recharging an emergency fire sprinkler system, the method comprising:
Connecting a first end of a transport device to a valve on a storage vessel;
Connecting a second end of said transport device to an entrance point of a fire sprinkler system;
Placing a pump at a first point along said transport device, said first point positioned between said storage vessel and said fire sprinkler system;
Placing a filter at a second point along said transport device, said second point positioned between said storage vessel and said fire sprinkler system;
Activating said pump to pull the contents from said storage vessel through said valve on said storage vessel and to push said contents along said transport device towards said entrance point of said fire sprinkler system;
Filling said fire sprinkler system with said contents from said storage vessel;
Closing said fire sprinkler system to hold said contents within said fire sprinkler system;
Closing said entrance point of a fire sprinkler system after said contents from said storage vessel are removed from said storage vessel.
